(19) United States
(12) Patent Application Publication
(10) Pub. No.: US 2004/0189047 A1
(43) Pub. Date: Sep. 30, 2004

(54) Reduced aerodynamic drag truck gate

(76) Inventor: Brian S. Barry, Wilmington, MA (US)

Correspondence Address: FISH & RICHARDSON PC, 225 FRANKLIN ST, BOSTON, MA, 02110, US

(21) Appl. No.: 10/397,618

(22) Filed: Mar. 26, 2003

(51) Int. Cl. B62D 25/00

(52) U.S. Cl. 296/180.1; 296/57.1

(57) ABSTRACT

A reduced-drag gate includes an interior surface and an exterior surface, both of which are affixed to a frame assembly. A pivot assembly allows the reduced-drag gate to pivot about a fixed pivot point of a truck. One or more closable passages, which connect the interior surface to the exterior surface, allow for the passage of air from the area proximate the interior surface to the area proximate the exterior surface. Each closable passage includes an airflow gate assembly, positioned between the interior surface and the exterior surface, that allows for the opening and closing of the closable passage.

### TECHNICAL FIELD

This description relates to truck gates.

### BACKGROUND

Trucks that include a tail/lift gate (e.g., pickup trucks and delivery trucks) are useful in that they allow for the easy loading and unloading of products into and out of their beds. While the open-top design of these beds facilitates easy loading and unloading of material, whenever these vehicles are driven, a closed tail/lift gate creates high levels of aerodynamic drag. Specifically, at highway speeds, air passing over the roof of the passenger compartment of the vehicle creates a low pressure area inside of the truck bed. This low pressure area, in turn, causes the air flow passing over the top of the passenger compartment to be drawn down into the bed. Unfortunately, this results in the air flow colliding with the closed tail/lift gate, such that the tail/lift gate essentially acts as a sail or open parachute, generating high levels of aerodynamic drag and lowering fuel efficiency.

To reduce drag, owners of these vehicles quite often drive with their tail/lift gate lowered. However, while this solves the problem concerning drag, often problems arise, such as requiring additional measures to keep the load within the bed of the truck and an unsafe driving condition, as the tail/lift gate extends out past the periphery of the bumper.

### SUMMARY

According to an aspect of this invention, a reduced-drag gate (e.g., a tail gate or a lift gate) includes an interior surface and an exterior surface, both of which are affixed to a frame assembly. A pivot assembly allows the reduced-drag gate to pivot about a fixed pivot point of a truck. One or more closable passages, which connect the interior surface to the exterior surface, allow for the passage of air from the area proximate the interior surface to the area proximate the exterior surface. Each closable passage includes an airflow gate assembly, positioned between the interior surface and the exterior surface, that allows for the opening and closing of the closable passage.

One or more of the following features may be included. The airflow gate assembly may include a slidable gate that slides from an opened position to a closed position, or a pivotable gate that pivots from an opened position to a closed position. Each airflow gate assembly include a locking assembly for locking the airflow gate assembly in an open position.

An actuator assembly (such as a rack and pinion assembly, a lever assembly, or a bell crank assembly) controls the airflow gate assembly. A latching assembly releasably locks the reduced-drag gate in a closed position.

A permeable mesh assembly spans the closable passage, such that the permeable mesh assembly allows for the passage of air from the area proximate the interior surface to the area proximate the exterior surface.

One or more advantages can be realized from the above-described embodiment. The reduced-drag gate allows a user to carry cargo, while still providing for aerodynamic operation. Further, as the passages within the tailgate are closable, the user may close these passages to prevent cargo from falling through them. Additionally, as the gate assemblies within the passages are contained within the body of the gate, the passages can be opened or closed while the truck bed is filled with cargo.

Other features will be apparent from the following description, including the drawings, and the claims.

### DESCRIPTION OF DRAWINGS

FIG. 1 is an isometric view of a pickup truck including a reduced-drag gate;

FIG. 2 is plan view of the reduced-drag gate of FIG. 1;

FIG. 3 is a plan view of an actuator assembly for the reduced-drag gate of FIG. 1

FIG. 4 is a plan view of another actuator assembly for the reduced-drag gate of FIG. 1

FIG. 5 is a plan view of another actuator assembly for the reduced-drag gate of FIG. 1

FIG. 6 is a plan view of another reduced-drag gate;

FIG. 7 is a plan view of another reduced-drag gate; and

FIG. 8 is a flowchart of a method of manufacturing a reduced-drag tailgate assembly.

Like reference numbers and designations in the various drawings indicate like elements.

### DETAILED DESCRIPTION

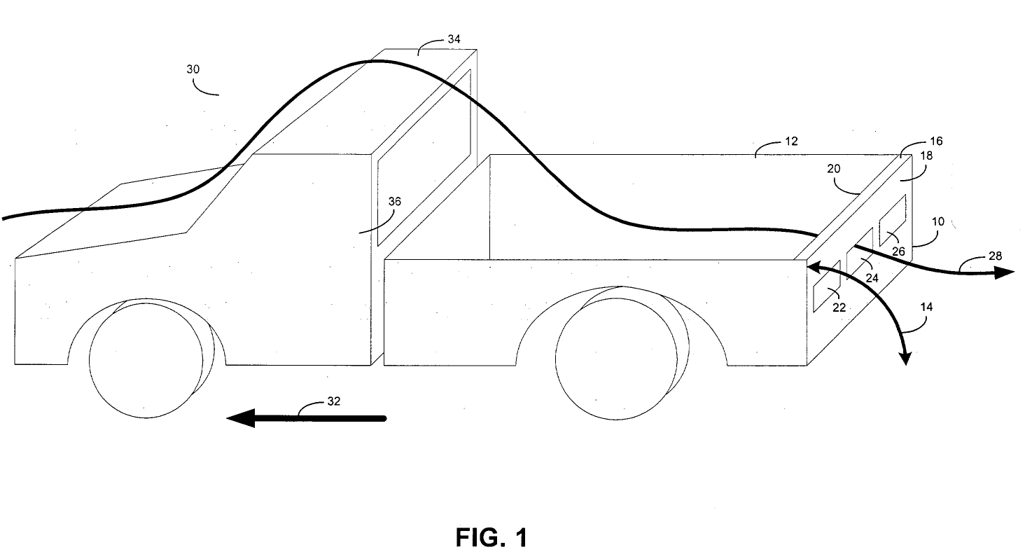

Referring to FIG. 1, a reduced-drag gate 10 is pivotally connected, via a pivot assembly (not shown, e.g., a pair of pins), to a truck bed assembly 12, such that gate 10 pivots in the direction of arrow 14. Gate 10 may be used as a tailgate on the bed of a pickup truck or a lift gate on the bed of an open top delivery truck. When used as a tailgate, reduced-drag gate 10 is typically removably attached to the pickup truck bed through the use of a pair of simple pin assemblies (not shown). When configured as a lift gate, reduced-drag gate 10 is typically attached to the delivery truck bed with a pivoting hydraulic lift assembly (not shown).

Reduced-drag gate 10 typically includes an essentially rectangular frame assembly 16, to which an exterior surface 18 and an interior surface 20 are attached. These surfaces 18, 20 may be constructed of various materials, such as stamped sheet metal, aluminum diamond plate, steel plate, or wood, for example. Additionally, frame assembly 16 may be incorporated into either of the surfaces 18, 20. For example, the ends of one or both surfaces 18, 20 may be flanged so that the flange is perpendicular to the surface itself, thus allowing the surfaces 18, 20 to be directly attached.

Reduced-drag gate 10 includes one or more closable passages 22, 24, 26 that allow for the passage of air (depicted by arrow 28) through the gate 10. Specifically, as truck 30 moves in the direction of arrow 32, air 28 passes over the roof 34 of truck cab 36 and is drawn downward due to the low pressure behind the rear of the truck cab 36. By allowing for the passage of air 28 through gate 10, closable passages 22, 24, 26 reduce the overall aerodynamic drag of truck 30.

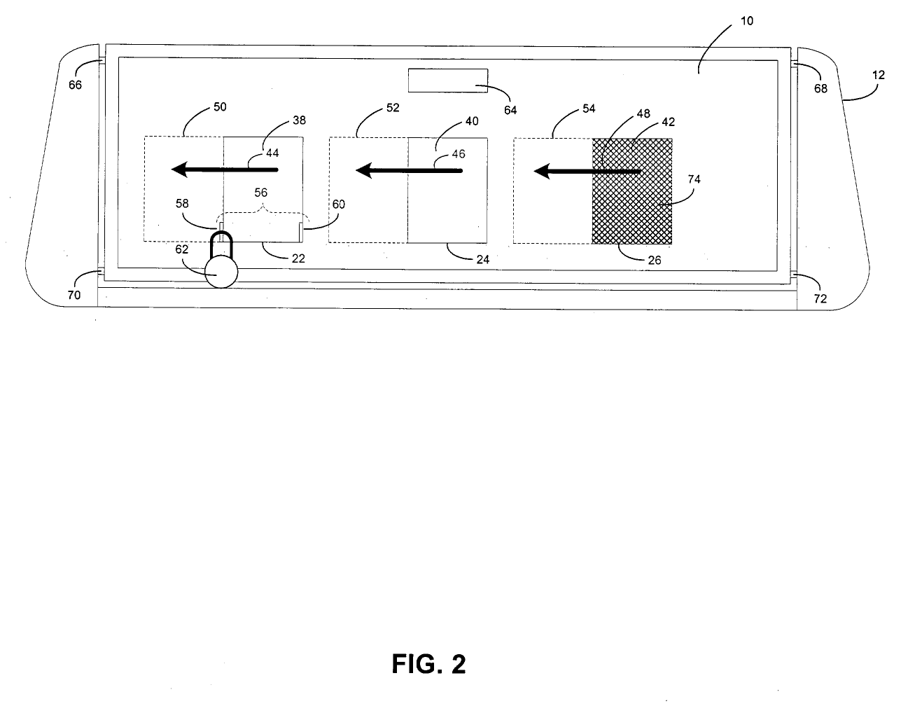

Referring to FIG. 2, each closable passage 22, 24, 26 includes an airflow gate assembly (e.g., airflow gate assembly 38) that is positioned between the surfaces 18, 20 (See FIG. 1) of reduced-drag gate 10 and allows for the closable passage to be opened and closed. In this particular embodiment, gate 10 includes three passages 22, 24, 26, each of which includes an airflow gate assembly 38, 40, 42 respectively. In this particular embodiment, the airflow gate assemblies consist of plate assemblies (typically contracted of steel) that slide horizontally to the left in the direction of arrows 44, 46, 48. When in the closed position, airflow gate assemblies 38, 40, 42 are positioned within their respective closable passages 22, 24, 26, thus preventing any small items contained within the truck bed from falling through passages 22, 24, 26. Additionally, when in the closed position, loose material (e.g., sand, loam, gravel, etc.) may be transported in the truck bed without passing through passages 22, 24, 26. However, when in the open position, airflow gate assemblies 38, 40, 42 slide between the surfaces 18, 20 (See FIG. 1) of the reduced-drag gate 10 into the position indicated by phantom lines 50, 52, 54 respectively. This, in turn, allows for the passage of air through the reduced-drag gate 10, thus reducing aerodynamic drag of the vehicle. As airflow gate assemblies 38, 40, 42 slide within the surfaces 18, 20 of gate assembly 10, the airflow gate assemblies can be opened and closed while the truck has a load within its bed. Each of these airflow gates assemblies 38, 40, 42 may be individually controlled or simultaneously controlled by an actuator assembly (to be discussed below in greater detail).

One or more of the airflow gate assemblies 38, 40, 42 may includes a locking assembly 56 that allows the user to lock the airflow gate assembly into the open or closed position. In this particular embodiment, the locking assembly includes a pair of hasps 58, 60, which abut each other when the airflow gate assembly is in the open position. A padlock 62 may then be used to hold the hasps together, thus locking the airflow gate assembly in the open position.

A latching assembly 64 releasable locks gate assembly 10 in the upright (i.e., closed) position. Latching assembly 64 typically includes a pair of pin 66, 68 that slide within gate 10 and, when extended, engage recesses (not shown) within truck bed assembly 12. When pins 66, 68 of latching assembly 64 are disengaged, a pivoting assembly (e.g., pins 70, 72) allows gate 10 to pivot in the direction of arrow 14 (See FIG. 1), thus allowing for the truck bed to be easily loaded and unloaded.

One or more of the closable passages (e.g., passage 26) may include a permeable mesh assembly 74 affixed within the passage, thus allowing for the passage of air but preventing small items (e.g., tools, structural lumber, etc.) from passing through the passage even when the respective airflow gate assembly 42 is open. As permeable mesh assembly 74 is rigidly affixed within the closable passage (e.g., closable passage 26), the airflow gate assembly (e.g., airflow gate assembly 42) positioned within the passage 26 is positioned in parallel with the permeable mesh assembly 74. Therefore, airflow gate assembly 42 would either slide in front of or behind permeable mesh assembly 74. Permeable mesh assembly 74 may be constructed of expanded metal or perforated metal, for example.

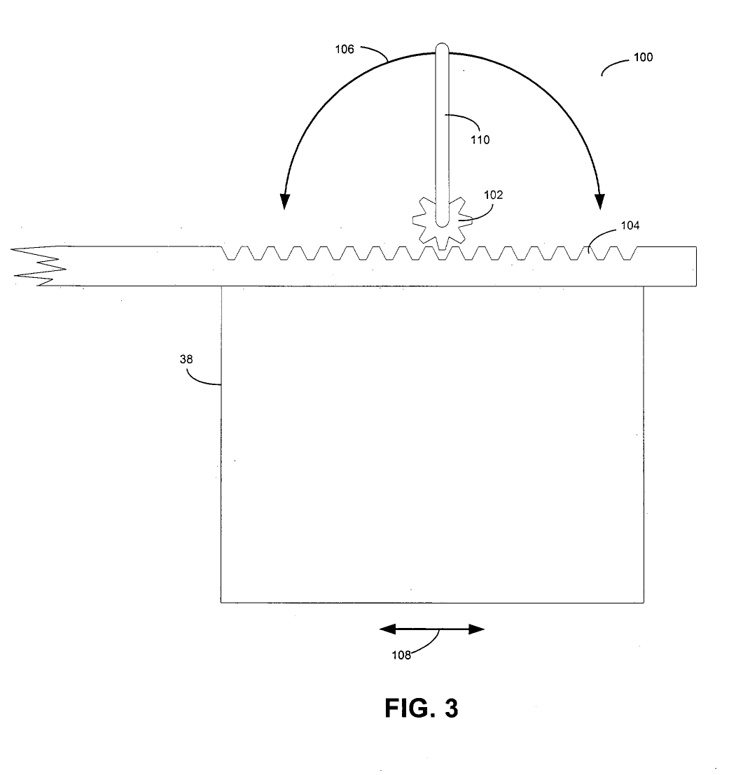

Referring to FIG. 3, a first embodiment of actuator assembly 100 is shown. In this embodiment, actuator assembly 100 includes a rack gear 102 that interfaces with a pinion gear 104. As the rack gear 102 is rigidly attached to the airflow gate assembly 38, any rotation of the rack gear 102 in the direction of arrow 106 is converted to linear movement of airflow gate assembly 38 (in the direction of arrow 108). To facilitate rotation of pinion gear 102, handle assembly 110 may be rigidly attached to pinion gear 104. Handle assembly 110 may be positioned within a pie-slice shaped recess (not shown) in the exterior or interior surfaces 18, 20 (See FIG. 1) of the reduced-drag gate 10. Actuator assembly 100 may be used to control a single or multiple airflow gate assemblies 38.

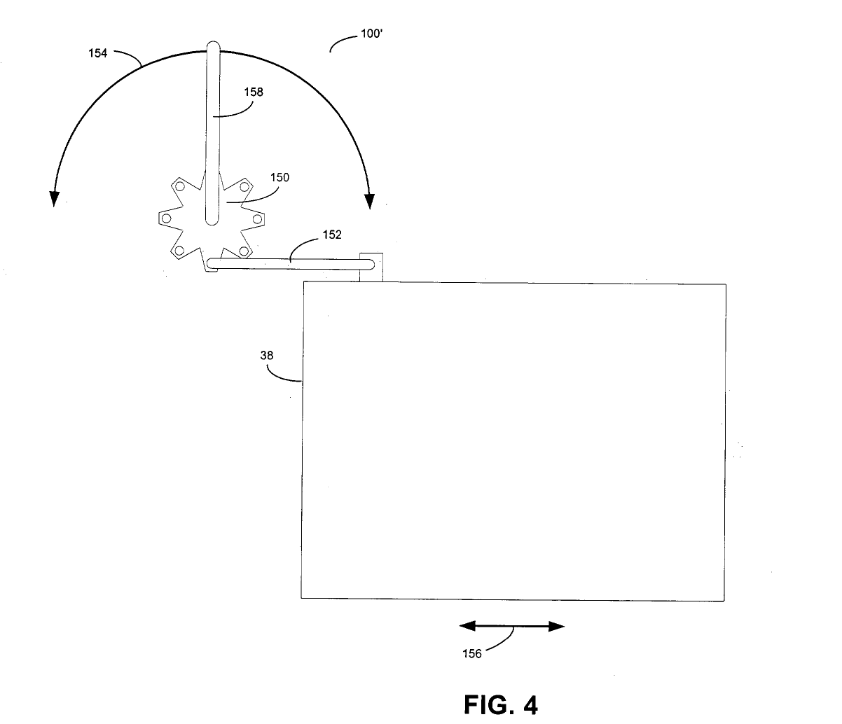

Referring to FIG. 4, a second embodiment of actuator assembly 100′ is shown. In this embodiment, actuator assembly 100′ includes a bell crank assembly 150 that interfaces with an actuation rod 152. As the actuation rod 152 is pivotally attached to the airflow gate assembly 38, any rotation of the bell crank assembly 150 in the direction of arrow 154 is converted to linear movement of airflow gate assembly 38 (in the direction of arrow 156). To facilitate rotation of bell crank assembly 150, handle assembly 158 may be rigidly attached to bell crank assembly 150. Handle assembly 158 may be positioned within a pie-slice shaped recess (not shown) in the exterior or interior surfaces 18, 20 (See FIG. 1) of the reduced-drag gate 10. Actuator assembly 100′ may be used to control a single or multiple airflow gate assemblies 38.

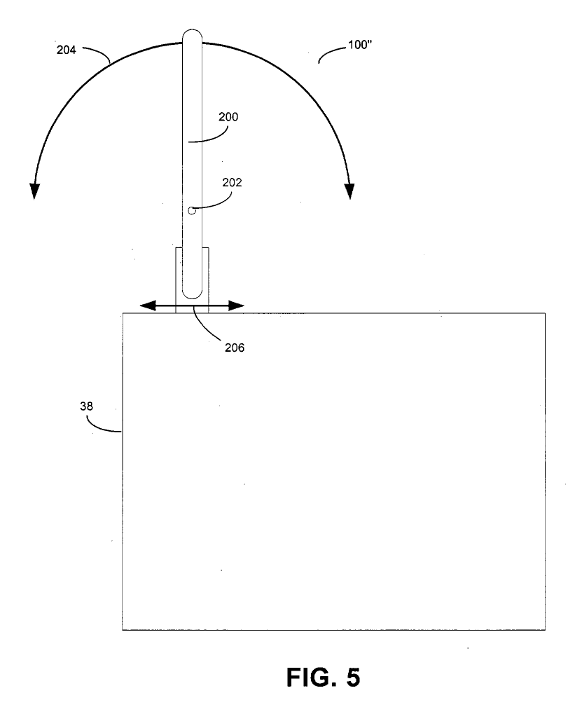

Referring to FIG. 5, a third embodiment of actuator assembly 100″ is shown. In this embodiment, actuator assembly 100″ includes a lever assembly 200 that pivots about a fixed pivot point 202. As lever assembly 200 is slidably and pivotally attached to the airflow gate assembly 38, any pivotal rotation of lever assembly 200 (in the direction of arrow 204) is converted to linear movement of airflow gate assembly 38 (in the direction of arrow 206). Lever assembly 200 may be positioned within a pie-slice shaped recess (not shown) in the exterior or interior surfaces 18, 20 (See FIG. 1) of the reduced-drag gate 10. Actuator assembly 100″ may be used to control a single or multiple airflow gate assemblies 38.

While FIG. 1 shows three closable passages 22, 24, 26, this is for illustrative purposes only, as the actual number of passages may be varied for design purposes.

While FIG. 2 shows the locking assembly 56 as a pair of hasps 58, 60 and a padlock 62, this is for illustrative purposes only, as other configurations are possible. For example, a bolt may be used instead of a pad lock, or a simple spring-loaded latch may perform the same function.

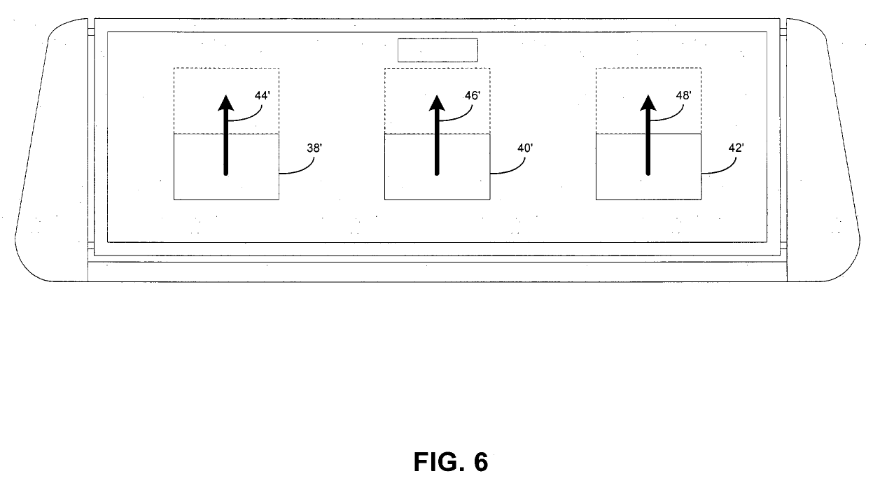

While FIG. 2 shows airflow gate assemblies 38, 40, 42 that include plates assemblies that slide horizontally to the left in the direction of arrows 44, 46, 48, other configurations are possible. For example and as shown in FIG. 6, airflow gate assemblies 38′, 40′, 42′ may be plate assemblies that slide vertically upward in the direction of arrows 44′, 46′, 48′.

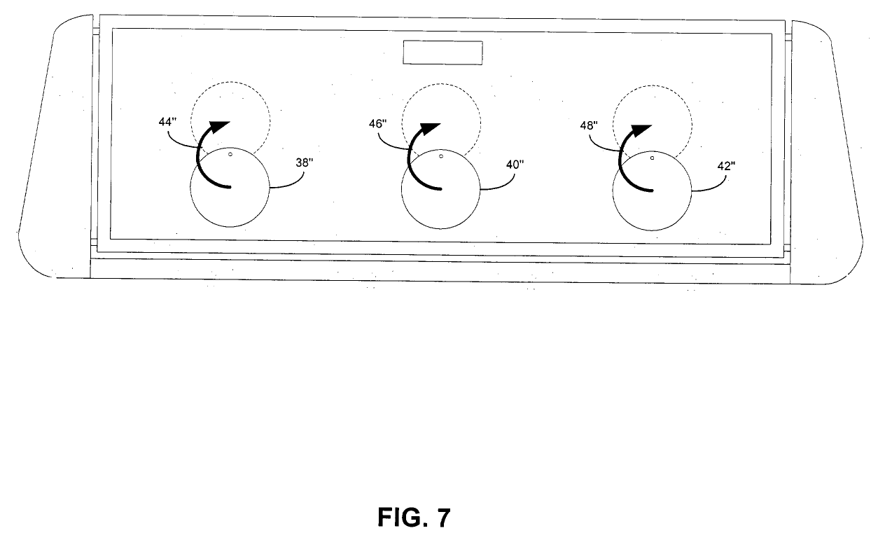

While FIG. 2 shows airflow gate assemblies 38, 40, 42 that are rectangular in shape and slide linearly in the direction of arrows 44, 46, 48, other configurations are possible. For example and as shown in FIG. 7, airflow gate assemblies 38″, 40″, 42″ may be circular in shape and pivot about a fixed pivot point in the direction of arrows 44″, 46″, 48″.

While FIGS. 3, 4, and 5 illustrate three embodiments 100, 100′, 100″ of the actuator assembly, these are for illustrative purposes only, as other configurations are possible. For example, a simple rigid rod may interconnect the airflow gate assemblies, such that sliding a single assembly results in the movement of all airflow gate assemblies.

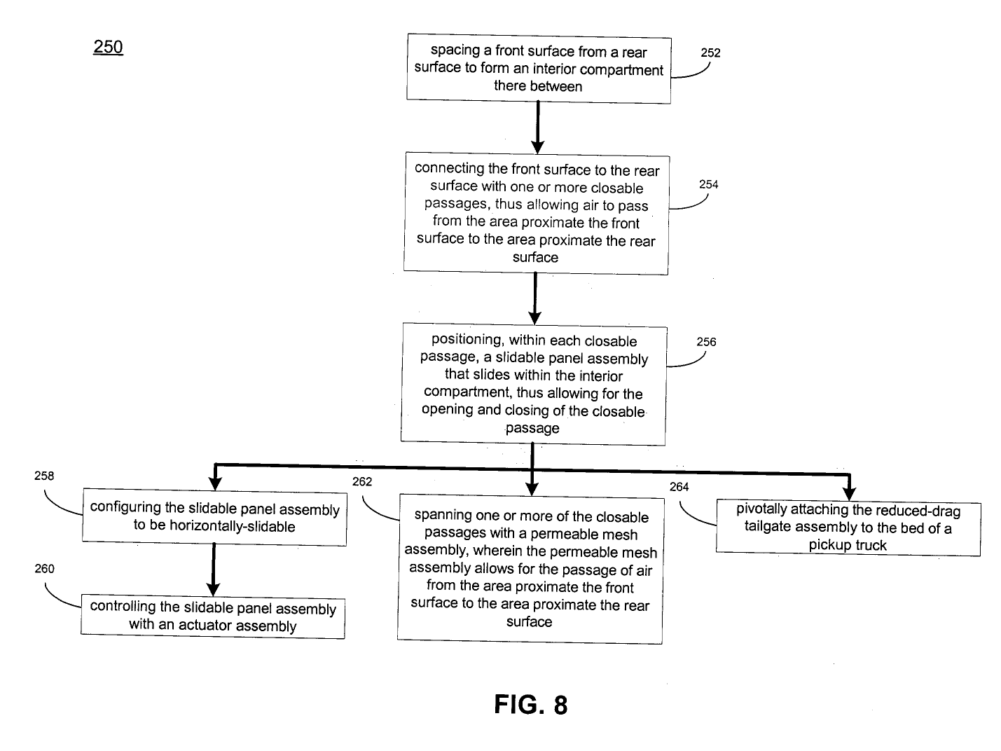

Referring to FIG. 8, there is shown a method 250 of manufacturing a reduced-drag tailgate assembly. A front surface is spaced apart 252 from a rear surface, thus forming an interior compartment there between. One or more closable passages connect 254 the front surface to the rear surface, thus allowing air to pass from the area proximate the front surface to the area proximate the rear surface. Each closable passage includes a slidable panel assembly, positioned 256 within the interior compartment, for allowing for the opening and closing of the closable passage.

The slidable panel assembly may be configured 258 to be horizontally-slidable and may be controlled 260 by an actuator assembly. One or more of the closable passages may include a permeable mesh assembly spanning 262 the closable passage. This permeable mesh assembly allows for the passage of air from the area proximate the front surface to the area proximate the rear surface.

The reduced-drag tailgate manufactured using method 250 may then be pivotally attached 264 to the bed of a pickup truck.

A number of implementations have been described. Nevertheless, it will be understood that various modifications may be made. Accordingly, other implementations are within the scope of the following claims.

What is claimed is:

1. A reduced-drag gate comprising:
a frame assembly;
an interior surface affixed to the frame assembly;
an exterior surface affixed to the frame assembly;
a pivot assembly for allowing the reduced-drag gate to pivot about a fixed pivot point of a truck; and
one or more closable passages connecting the interior surface to the exterior surface, wherein the one or more closable passages allow for the passage of air from the area proximate the interior surface to the area proximate the exterior surface;
wherein each closable passage includes an airflow gate assembly, positioned between the interior surface and the exterior surface, for allowing for the opening and closing of the closable passage.

2. The reduced-drag gate of claim 1 wherein the airflow gate assembly includes a slidable gate that slides from an opened position to a closed position.

3. The reduced-drag gate of claim 1 wherein the airflow gate assembly includes a pivotable gate that pivots from an opened position to a closed position.

4. The reduced-drag gate of claim 1 wherein each airflow gate assembly include a locking assembly for locking the airflow gate assembly in an open position.

5. The reduced-drag gate of claim 1 further comprising an actuator assembly for controlling the airflow gate assembly.

6. The reduced-drag gate of claim 5 wherein the actuator assembly is a rack and pinion assembly.

7. The reduced-drag gate of claim 5 wherein the actuator assembly is a lever assembly.

8. The reduced-drag gate of claim 5 wherein the actuator assembly is a bell crank assembly.

9. The reduced-drag gate of claim 1 wherein one or more of the closable passages includes a permeable mesh assembly spanning the closable passage, wherein the permeable mesh assembly allows for the passage of air from the area proximate the interior surface to the area proximate the exterior surface.

10. The reduced drag gate assembly of claim 1 further comprising a latching assembly for releasably locking the reduced-drag gate in a closed position.

11. The reduced drag gate of claim 1 wherein the reduced-drag gate is a tail gate.

12. The reduced drag gate of claim 1 wherein the reduced-drag gate is a lift gate.

13. A reduced-drag tailgate assembly comprising:
a front surface spaced apart from a rear surface, forming an interior compartment there between; and
one or more closable passages connecting the front surface to the rear surface for allowing air to pass from the area proximate the front surface to the area proximate the rear surface;
wherein each closable passage includes a slidable panel assembly, positioned within the interior compartment, for allowing for the opening and closing of the closable passage.

14. The reduced-drag tailgate assembly of claim 13 wherein the slidable panel assembly is configured to be vertically-slidable.

15. The reduced-drag tailgate assembly of claim 13 wherein the slidable panel assembly is configured to be horizontally-slidable.

16. The reduced-drag tailgate assembly of claim 13 wherein each slidable panel assembly includes a locking assembly for locking the slidable panel assembly in an open position.

17. The reduced-drag tailgate assembly of claim 13 wherein one or more of the closable passages includes a permeable mesh assembly spanning the closable passage, wherein the permeable mesh assembly allows for the passage of air from the area proximate the front surface to the area proximate the rear surface.

18. The reduced-drag tailgate assembly of claim 13 further comprising a pivot assembly for allowing the reduced-drag tailgate assembly to pivot about a fixed pivot point of a truck.

19. The reduced-drag tailgate assembly of claim 18 further comprising a latching assembly for releasable locking the reduced-drag tailgate assembly in a closed position.

20. The reduced-drag tailgate assembly of claim 13 further comprising an actuator assembly for controlling the slidable panel assembly.

21. The reduced-drag tailgate assembly of claim 20 wherein the actuator assembly is a rack and pinion assembly.

22. The reduced-drag tailgate assembly of claim 20 wherein the actuator assembly is a lever assembly.

23. The reduced-drag tailgate assembly of claim 20 wherein the actuator assembly is a bell crank assembly.

24. A pickup truck comprising:
a frame assembly;
a truck cab attached to the frame assembly;
a truck bed attached to the frame assembly; and
a reduced-drag tailgate assembly pivotally attached to the truck bed including:
a front surface spaced apart from a rear surface, forming an interior compartment there between; and
one or more closable passages connecting the front surface to the rear surface for allowing air to pass from the area proximate the front surface to the area proximate the rear surface;
wherein each closable passage includes a slidable panel assembly, positioned within the interior compartment, for allowing for the opening and closing of the closable passage.

25. The pickup truck of claim 24 wherein the slidable panel assembly is configured to be horizontally-slidable.

26. The pickup truck of claim 24 wherein one or more of the closable passages includes a permeable mesh assembly spanning the closable passage, wherein the permeable mesh assembly allows for the passage of air from the area proximate the front surface to the area proximate the rear surface.

27. The pickup truck of claim 24 further comprising an actuator assembly for controlling the slidable panel assembly.

28. The pickup truck of claim 27 wherein the actuator assembly is a rack and pinion assembly.

29. The pickup truck of claim 27 wherein the actuator assembly is a lever assembly.

30. The pickup truck of claim 27 wherein the actuator assembly is a bell crank assembly.

31. A method of manufacturing a reduced-drag tailgate assembly comprising:
spacing a front surface from a rear surface to form an interior compartment therebetween;
connecting the front surface to the rear surface with one or more closable passages, thus allowing air to pass from the area proximate the front surface to the area proximate the rear surface; and
positioning, within each closable passage, a slidable panel assembly that slides within the interior compartment, thus allowing for the opening and closing of the closable passage.

32. The method of claim 31 further comprising:
configuring the slidable panel assembly to be horizontally-slidable.

33. The method of claim 31 further comprising:
spanning one or more of the closable passages with a permeable mesh assembly, wherein the permeable mesh assembly allows for the passage of air from the area proximate the front surface to the area proximate the rear surface.

34. The method of claim 31 further comprising controlling the slidable panel assembly with an actuator assembly.

35. The method of claim 34 wherein the actuator assembly is a rack and pinion assembly.

36. The method of claim 34 wherein the actuator assembly is a lever assembly.

37. The method of claim 34 wherein the actuator assembly is a bell crank assembly.

38. A method of increasing fuel efficiency comprising:
spacing a front surface from a rear surface to form an interior compartment there between;
connecting the front surface to the rear surface with one or more closable passages, thus allowing air to pass from the area proximate the front surface to the area proximate the rear surface;
positioning, within each closable passage, a slidable panel assembly that slides within the interior compartment and allows for the opening and closing of the closable passage, thus forming a reduced-drag tailgate assembly; and
pivotally attaching the reduced-drag tailgate assembly to the bed of a pickup truck.

39. The method of claim 38 further comprising:
configuring the slidable panel assembly to be horizontally-slidable.

40. The method of claim 38 further comprising:
spanning one or more of the closable passages with a permeable mesh assembly, wherein the permeable mesh assembly allows for the passage of air from the area proximate the front surface to the area proximate the rear surface.

41. The method of claim 38 further comprising controlling the slidable panel assembly with an actuator assembly.

42. The method of claim 41 wherein the actuator assembly is a rack and pinion assembly.

43. The method of claim 41 wherein the actuator assembly is a lever assembly.

44. The method of claim 41 wherein the actuator assembly is a bell crank assembly.

45. A method of reducing aerodynamic drag comprising:
spacing a front surface from a rear surface to form an interior compartment there between;
connecting the front surface to the rear surface with one or more closable passages, thus allowing air to pass from the area proximate the front surface to the area proximate the rear surface;
positioning, within each closable passage, a slidable panel assembly that slides within the interior compartment and allows for the opening and closing of the closable passage, thus forming a reduced-drag tailgate assembly; and
pivotally attaching the reduced-drag tailgate assembly to the bed of a pickup truck.

46. The method of claim 45 further comprising:
configuring the slidable panel assembly to be horizontally-slidable.

47. The method of claim 45 further comprising:
spanning one or more of the closable passages with a permeable mesh assembly, wherein the permeable mesh assembly allows for the passage of air from the area proximate the front surface to the area proximate the rear surface.

48. The method of claim 45 further comprising controlling the slidable panel assembly with an actuator assembly.

49. The method of claim 48 wherein the actuator assembly is a rack and pinion assembly.

50. The method of claim 48 wherein the actuator assembly is a lever assembly.

51. The method of claim 48 wherein the actuator assembly is a bell crank assembly.
